(19) United States
(12) Patent Application Publication
(10) Pub. No.: US 2009/0154581 A1
(43) Pub. Date: Jun. 18, 2009

(54) Discrete Multitone(DMT) Communications without Using a Cyclic Prefix

(76) Inventor: Maxim B. Belotserkovsky, Carmel, IN (US)

Correspondence Address: Thomson Licensing LLC, P.O. Box 5312, Two Independence Way, PRINCETON, NJ, 08543-5312, US

(21) Appl. No.: 12/226,802

(22) PCT Filed: May 1, 2006
(86) PCT No.: PCT/US06/16495

§ 371 Date: Oct. 28, 2008

(51) Int. Cl. H04L 27/28

(52) U.S. Cl. 375/260

(57) ABSTRACT

A Discrete Multitone (DMT) modulator modulates symbols with subcarriers for providing DMT symbols, wherein the subcarriers are divided into a number of subcarrier subsets such that adjacent DMT symbols formed from different subcarrier subsets

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

In a Discrete Multitone (DMT) transmission system, it is customary to also transmit a so-called Cyclic Prefix (CP) along with each DMT symbol to help mitigate multipath effects. Unfortunately, the use of a CP increases the DMT symbol duration for the same payload, thus reducing the information throughput of the system.

However, if such mitigation measures are not taken, the presence of multipath will result in Inter Symbol Interference.(ISI), which demands a much more complex receiver and will likely produce an irreducible signal distortion at the output of the DMT receiver. For example, if a CP is not used at all, or if a CP is used that is much shorter than the expected multipath delay, ISI will unavoidably occur when the multipath length exceeds the length of the CP. In order to try and reduce the effects of ISI in such a system, the DMT receiver typically also includes a Time Domain (TD) equalizer in addition to, or instead of, the Frequency Domain (FD) equalizer commonly employed in the DMT receiver. Unfortunately, this method is very expensive to implement in the DMT receiver, both in terms of the size of the hardware required and in terms of the processing time necessary to perform the TD equalization, which is usually recursive in nature for such systems.

### SUMMARY OF THE INVENTION

I have realized that in some Discrete MultiTone (DMT) systems it is possible to eliminate the need for a cyclic prefix without increasing the complexity or cost of the DMT receiver as described above. In particular, and in accordance with the principles of the invention, a DMT modulator modulates symbols with subcarriers for providing DMT symbols, wherein the subcarriers are divided into a number of subcarrier subsets such that adjacent DMT symbols are formed from different subcarrier subsets. Thus, for some DMT systems greater information throughput can be achieved by not using a cyclic prefix without incurring an appreciable increase in receiver complexity.

In an embodiment of the invention, a transmitter comprises a DMT modulator for providing a sequence of DMT symbols, where for any subcarrier Sᵢ of a DMT symbol Xₖ, the previous and following DMT symbols, Xₖ₋₁ and Xₖ₊₁, do not contain the same-numbered subcarrier. For example, the DMT modulator uses a set of six subcarriers: S₁, S₂, S₃, S₄, S₅ and S₆ for producing DMT symbols. This set of subcarriers is divided into two subsets of subcarriers, where a first subset comprises subcarriers S₁, S₃ and S₅ and a second subset comprises subcarriers S₂, S₄ and S₆. The first and second subsets are disjoint. The DMT modulator uses the first subset to provide one DMT symbol and then the second subset for providing the following DMT symbol. In other words, the first subset is used for transmission of even DMT symbols, and the second subset is used for transmission of odd DMT symbols (or vice versa).

In view of the above, and as will be apparent from reading the detailed description, other embodiments and features are also possible and fall within the principles of the invention.

### BRIEF DESCRIPTION OF THE DRAWINGS

FIGS. 1-3 illustrate prior art NTSC transmission;

FIG. 4 shows an illustrative embodiment of an ATSC-DTV system in accordance with the principles of the invention;

FIG. 5 shows an illustrative embodiment of a transmitter for use in the system of FIG. 4 in accordance with the principles of the invention;

FIGS. 6-9 show an illustrative DMT transmission;

FIGS. 10-15 show illustrative DMT transmission in accordance with the principles of the invention;

FIG. 16 shows another illustrative embodiment of a transmitter for use in the system of FIG. 4 in accordance with the principles of the invention;

FIG. 17 shows an illustrative embodiment of a device for receiving an auxiliary channel in accordance with the principles of the invention;

FIG. 18 shows an illustrative embodiment of a receiver in accordance with the principles of the invention;

FIG. 19 shows an illustrative flow chart for use in a receiver in accordance with the principles of the invention; and

FIG. 20 shows another illustrative embodiment of a receiver in accordance with the principles of the invention.

### DETAILED DESCRIPTION

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Likewise, other than the inventive concept, other transmission concepts such as eight-level vestigial sideband (8-VSB), Quadrature Amplitude Modulation (QAM), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the FIGS. represent similar elements.

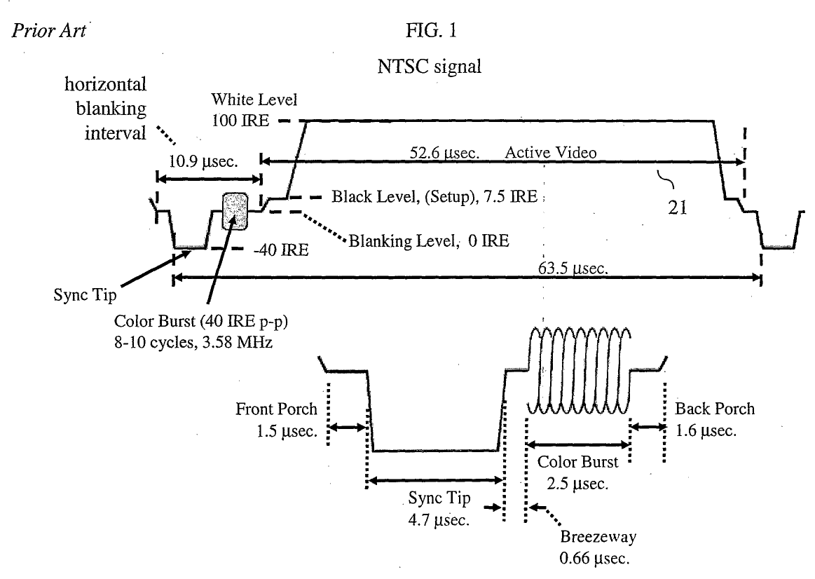

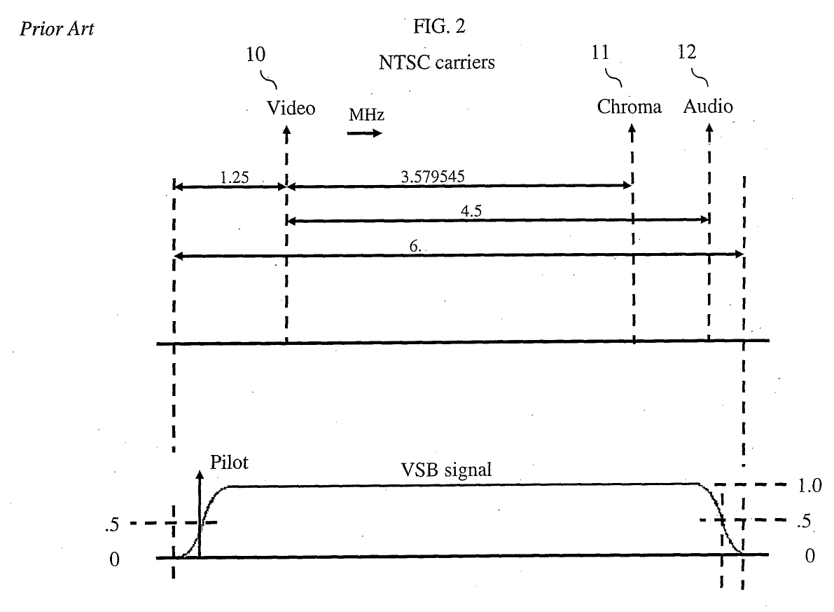

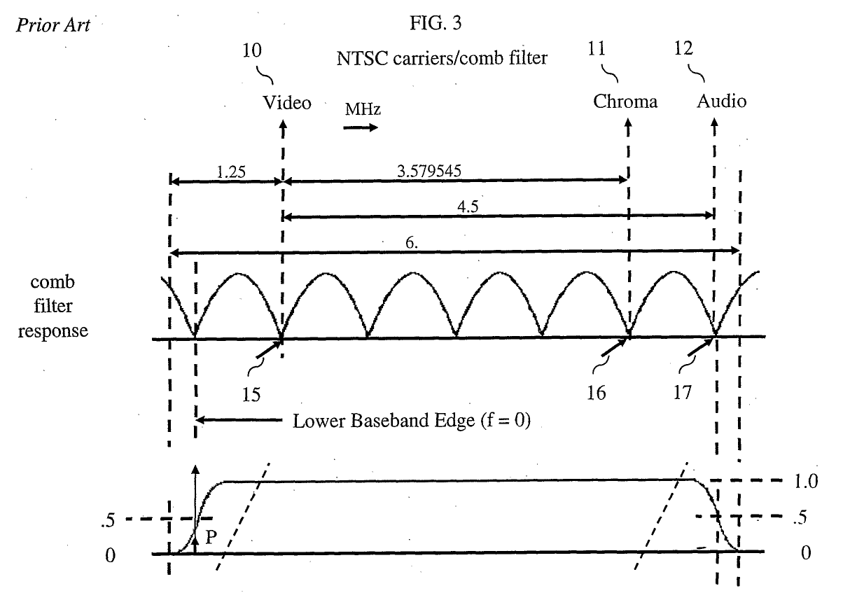

The inventive concept will be described in the context of an ATSC Auxiliary Channel. However, the inventive concept is not so limited and is applicable to any DMT-based system. Before describing the inventive concept, some brief background information on a legacy ATSC receiver and, in particular, on an NTSC system is described and shown in FIGS. 1-3. FIG. 1 shows a sample time domain (TD) representation of an NTSC signal as known in the art. A corresponding frequency spectrum of an NTSC signal transmission is shown in FIG. 2. Of particular note is that the bulk of the NTSC energy is located in specific areas of the spectrum, i.e., around the picture carrier (video 10), the sound carrier (audio 12) and the chroma carrier (chroma 11). Currently, an ATSC legacy receiver is inherently capable of rejecting an NTSC transmission (of limited power) located in-band of the desired ATSC channel (the so-called NTSC co-channel). In many ATSC legacy receivers currently on the market this rejection is facilitated by either the use of the so-called comb filter or by the main channel equalizer. In both of these cases, the ATSC legacy receiver is relying on the fact that the bulk of the energy of the NTSC co-channel is concentrated in the above-noted specific areas rather than being spread evenly across the band. As such, and as known in the art, it is relatively easy to remove this energy with a comb filter. In particular, the comb filter will actually remove this energy in 12 evenly-spaced locations in the full spectrum (roughly 10.76 MHz (millions of hertz)). However, in a single sideband 8-VSB signal only half of the spectrum, 5.38 MHz, is available. As such, the number of nulls is 7, of which one coincides with the ATSC pilot signal. The operation of the comb filter is shown in FIG. 3, which illustrates three of the comb filter nulls as indicated by arrows 15, 16 and 17, which correspond to the video 10, audio 12 and chroma 11 carriers, respectively.

However, and as described in the commonly owned International Patent Application No. PCT/US2005/045170 filed Dec. 13, 2005, a co-channel information-bearing transmission—from now on referred to as the Auxiliary Channel (AC)—is designed in such a way as to mimic one, or more, spectral Frequency Domain (FD) properties of a true NTSC co-channel transmission, thus allowing legacy ATSC receivers to effectively reject it. As a result, the AC enables additional information to be sent to an ATSC receiver—yet legacy ATSC receivers will not be significantly affected, i.e., the system is backward-compatible. The use of the AC channel described herein facilitates a number of services. For example, an ATSC broadcaster can use the AC to transmit an AC stream inside the broadcaster's own licensed ATSC band to, e.g., facilitate mobile reception of the ATSC transmission, provide a lower resolution video signal, etc. As used herein, this additional information is referred to as auxiliary data that supports one, or more, services provided via the ATSC signal. The auxiliary data can represent, e.g., training information, content (video and/or audio), setup information, system information, program information, etc.

In addition, since legacy ATSC receivers may rely on specific TD portions of an NSTC co-channel interferer to recognize the interferer as such (e.g., the NTSC horizontal and vertical blanking intervals and syncs, etc.), the proposed AC signal can advantageously imitate those as well. It should be noted that these TD portions of the signal, such as “dummy” syncs, are not entirely wasteful but can actually be used by a receiver for synchronization purposes, etc. However, it is not required that the AC signal provide, e.g., these “dummy” syncs or that the receiver use them even if these “dummy” syncs are provided.

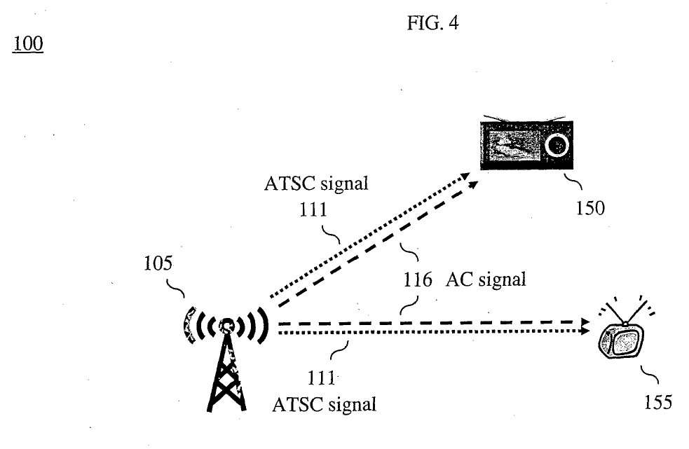

Turning now to FIG. 4, an illustrative embodiment of an ATSC-DTV system 100 in accordance with the principles of the invention is shown. ATSC DTV system 100 comprises an ATSC DTV transmitter 105 and at least one ATSC DTV receiver. The latter is represented in FIG. 4 by mobile DTV 150 and a DTV 155. Mobile DTV 150 is a small, portable, DTV, e.g., hand-held, and DTV 155 is representative of a more conventionally-sized DTVs for use, e.g., in a home. ATSC DTV transmitter 105 broadcasts an ATSC signal 111 as known in the art and represented in dotted-line form in FIG. 4. ATSC signal 111 is a data-bearing signal in the form of a packetized data stream and is modulated in an 8-VSB format. This is also known in the art as a “physical transmission channel” (PTC). The PTC has a center frequency (carrier frequency) and bandwidth. The PTC offers about 19 Mbits/sec (millions of bits per second) for transmission of an MPEG2-compressed HDTV (high definition TV) signal (MPEG2 refers to Moving Picture Expert Group (MPEG)-2 Systems Standard (ISO/IEC 13818-1)). As such, around four to six standard definition TV channels can be safely supported in a single PTC without congestion.

In addition, and in accordance with the principles of the invention, ATSC DTV transmitter 105 also broadcasts an AC signal 116, represented in dashed-line form in FIG. 4. As noted above, and described further below, AC signal 116 looks like a co-channel NTSC signal but, in fact, conveys auxiliary data for use by an ATSC receiver, such as mobile DTV 150 and/or DTV 155. This auxiliary data enables the provisioning of additional services to ATSC receivers—yet does not affect a legacy ATSC receiver.

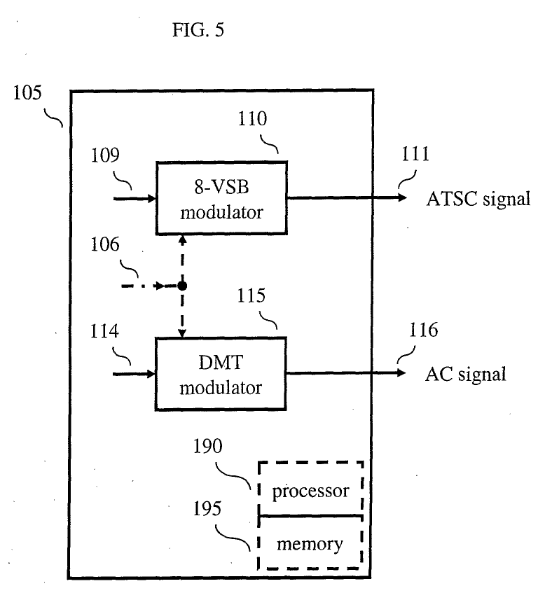

An illustrative embodiment of transmitter 105 is shown in FIG. 5. Transmitter 105 comprises an 8-VSB modulator 110 and a DMT modulator 115, which in accordance with the principles of the invention, provides the auxiliary channel. As noted above, the AC imitates, or mimics, an NTSC co-channel. In order to achieve the desired spectral properties (i.e., energy concentrated one, or more, specific areas of the spectrum), the preferred modulation method is to use a variant of a discrete (orthogonal) multitone (DMT) signal to carry the AC information. Other than the inventive concept, those familiar with DMT (also referred to as OFDM or COFDM) principles will recognize why such a transmission can be designed to have the desired spectral properties and will also appreciate other advantages of using DMT-based transmission, especially in terms of the ease of equalization of such a signal. In addition, transmitter 105 is a processor-based system and includes one, or more, processors and associated memory as represented by processor 190 and memory 195 shown in the form of dashed boxes in FIG. 5. In this context, computer programs, or software, are stored in memory 195 for execution by processor 190. The latter is representative of one, or more, stored-program control processors and these do not have to be dedicated to the transmitter function, e.g., processor 190 may also control other functions of transmitter 105. Memory 195 is representative of any storage device, e.g., random-access memory (RAM), read-only memory (ROM), etc.; may be internal and/or external to transmitter 105; and is volatile and/or non-volatile as necessary. The 8-VSB modulator 110 receives signal 109, which is representative of a data-bearing signal for conveying DTV program and system information, and modulates this data-bearing signal to provide ATSC signal 111 for broadcast on a particular PTC. In accordance with the principles of the invention, DMT modulator 115 receives signal 114, which is representative of a data-bearing signal for conveying auxiliary data, and modulates this data-bearing signal, as described below, to provide AC signal 116 for broadcast on the same PTC as was used for ATSC signal 111.

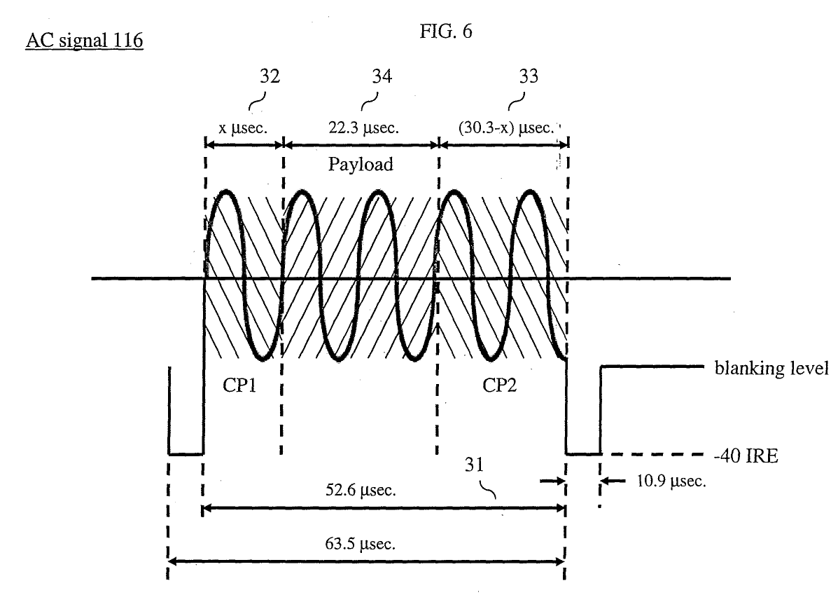

Referring now to FIG. 6, the operation of DMT modulator 115 is shown in the context of using DMT modulation for producing AC signal 116 with one, or more, of the desired spectral properties of an NTSC signal. In particular, FIG. 6 shows an illustrative portion of an AC signal imitating a single NTSC line, which is the basic building block for the AC co-channel waveform. It should be noted that the portion corresponding to an NTSC horizontal blanking period is drawn in a simplified way only to signify the fact that the corresponding portion of the AC signal does not carry a payload. As shown in FIG. 6, the AC information content is advantageously transmitted during a time interval 31 that corresponds to the active video interval (21) of the NTSC line shown in FIG. 1. Other than the inventive concept, the AC information can be encoded as magnitude and/or phase of a section of a complex/real sine-wave as known in the art. The single sine-wave shown in FIG. 6 is drawn for illustration purposes only. The frequencies of the sine-waves should be selected to place the energy of the AC transmission in at least one of the areas where a co-channel interfering NTSC picture carrier, NTSC sound carrier and/or NTSC chroma carrier would be expected as shown in FIG. 2. In the context of a DMT transmission, it should be noted that only a portion of interval 31 contains the AC payload waveform. In particular, and in accordance with DMT transmission, portions of the interval 31 are allocated to cyclic extensions (or cyclic prefixes (CPs) or guardbands) to help cope with multipath. These are shown in FIG. 6 as CP1 and CP2, which are allocated as shown to portions 32 and 33, respectively. As a result, the AC payload is allocated to portion 34 of interval 31. It should be noted that since AC signal 116 is a co-channel interferer to the ATSC signal 111. it may be preferable that the power level of AC signal 116 be set so that the ratio of the power of AC signal 116 to the power level of ATSC signal 111 be comparable to what is generally expected of an actual NTSC co-channel interferer. Indeed, since a broadcaster may control both ATSC signal 111 and AC signal 116, this power ratio (analogous to the desired-to-undesired (D/U) ratio in ATSC broadcast) may be adjusted in a static and/or a dynamic fashion via one, or more, signals as represented by signal 106, which is shown in dashed-line form in FIG. 5.

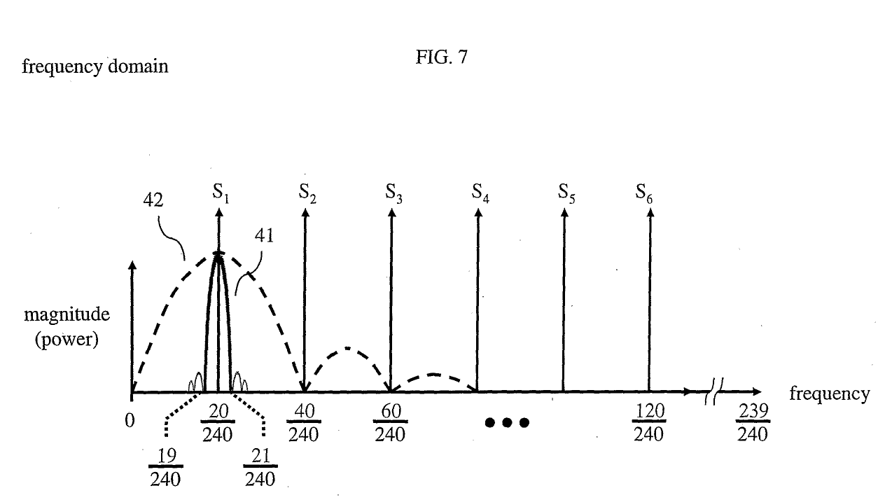

In FIG. 6, exemplary numerical values have been assigned to the respective portions of interval 31. For example, portion 34 is allocated to 22.3 μsec (microsecond). As such, the inverse of the payload length is exactly 1/120-th of the ATSC signal bandwidth of 5.38 MHz, which allows for 6 orthogonal AC subcarriers to be placed within an ATSC spectrum 5.38 MHz/6=897 kHz (thousands of hertz) apart (as noted above, one of the 7 nulls is associated with the ATSC pilot signal). This is further illustrated in FIG. 7, which shows an illustrative power spectral density for AC signal 116 having 6 subcarriers, where (fₖ−fₖ₋₁)=897 kHz. The specific fₖ values are selected to match one, or more, of the 6 frequency locations notched-out by the comb filter of an ATSC receiver as illustrated earlier in FIG. 3. In the time domain (TD), each DMT (OFDM) symbol is comprised of the sum of the subcarriers, each with its appropriate phase and magnitude, windowed to a desired length. Illustratively, the length of the time domain window in this example is picked to be a large multiple of the minimal orthogonality interval of the subcarriers. This is illustrated in FIG. 7 by the inner envelope 41 as compared to using the minimum-length (12) TD window as represented by the outer dashed line 42 around S₁. This is done to concentrate the signal energy in very narrow regions around the desired spectral locations, which is dictated by the constraints placed on the Auxiliary Channel transmission. (It should be noted that in a conventional DMT system this multiple is, usually, equal to ‘1’).

Returning briefly to FIG. 6, it can be observed that the use of a CP reduces the information throughput of the system. For example, the payload portion, 34, is only 22.3 μsec. of the 52.6 μsec. available. However, I have realized that if each TD symbol duration is chosen to be substantially longer than the minimal orthogonality interval of the 6 subcarriers, then—in the absence of a CP—the multipath will affect this transmission in a rather special way. In particular, for any multipath delay (i.e., for any duration of the overlap between the adjacent symbols), each of the subcarriers in a given symbol will be mostly affected by the same-numbered subcarriers of the adjacent symbols.

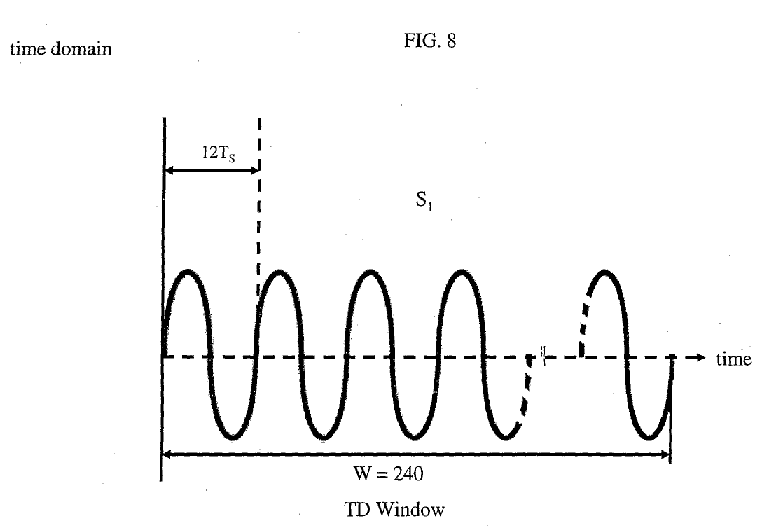

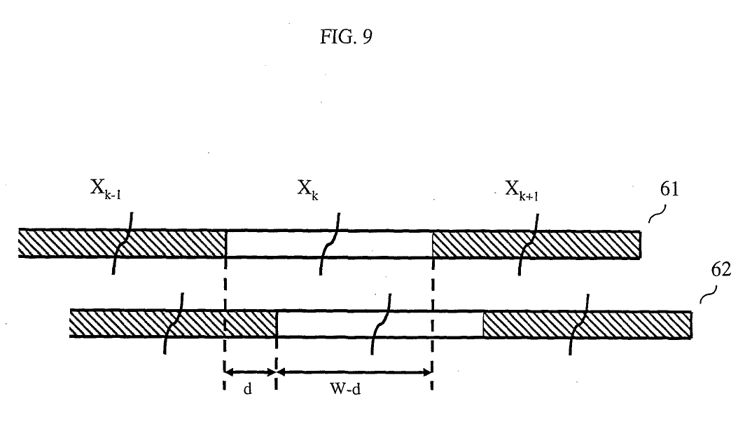

This point can be further clarified by referring, again, to FIG. 7, with regard to the subcarriers designated S₁ thru S₆. The frequency of S₁ is 20/240= 1/12 (frequencies are given as fractions of the chosen sampling rate, F_{S} which in this example equals 2*5.38 MHz=10.76 MHz). The frequencies of the other 5 subcarriers are integer multiples of that of S₁ as shown in FIG. 7. Since the subcarrier frequencies are all integer multiples of 1/12*F_{S}, the minimal time interval over which they are orthogonal to each other is 12*1/F_{S}=12*T_{S} (where T_{S} is the TD sampling interval). As such, if this were a conventional DMT-based system, the required TD window length would be 12*T_{S}. However, and as noted above, in this example the TD symbol duration is chosen to be substantially longer than the minimal orthogonality interval of the 6 subcarriers to allow for the energy of the subcarriers to be concentrated in a much narrower frequency region. For example, let the TD window duration, W, have a value of W=240, or 20 times the orthogonality interval. An exemplary TD plot of a single DMT symbol for a value of W=240 is shown in FIG. 8 (a single subcarrier S₁ is shown for illustrative purposes only). With this in mind, attention should now be directed of FIG. 9, which shows an illustration of a time domain sequence for three transmitted DMT symbols Xₖ₋₁, Xₖ and Xₖ₊₁. The top portion, 61, is assumed to represent the main path; while the bottom portion, 62, is representative of a ‘ghost’—the main path symbol stream delayed by d samples, which is then added to the main path (i.e., a multipath). As can be observed from FIG. 9, the symbol Xₖ, overlaps with a portion of itself (length W-d) and a portion of the preceding symbol Xₖ₋₁ (length d). If, for example, this time domain sequence is looked at from the perspective of the subcarrier S₁ both of these overlapping portions are projected onto subcarrier S₁ producing a two-fold effect. First, phase and magnitude of the subcarrier S₁ in each symbol in the main path sequence is going to be changed by some fixed complex factor depending on the magnitude of the ghost and delay d. Second, a noise-like contribution will be added to the subcarrier S₁ of each symbol in the main path sequence. The first effect is due to the contribution of the delayed version of S₁ of the symbol Xₖ itself and can be easily negated thru the use of a simple 1-tap equalizer, while the second effect is due to the contribution of S₁ of symbol Xₖ₋₁ as well as the contribution of the subcarriers S₂ thru S₆ of both Xₖ and Xₖ₋₁ and is much harder (if at all possible) to cancel.

Observations can also be made about the contributions from subcarrier S₁ of Xₖ₋₁ with the contributions from the other subcarriers. In particular, the former grows linearly as a function of d, potentially attaining a value equal to that of the desired contribution of S₁ of Xₖ itself, when d=W. In the latter, the contributions of S₂ thru S₆, of both Xₖ and Xₖ₋₁, grow only as a function of d modulo 12, never exceeding (12/240)²=1/400 of the power of the desired contribution to S₁. Thus, these latter contributions can be neglected, especially if they are substantially smaller than contributions expected from other interference sources in the receiver. In the context of the example shown in FIG. 4, this situation applies since the AC power is well below the main ATSC channel power.

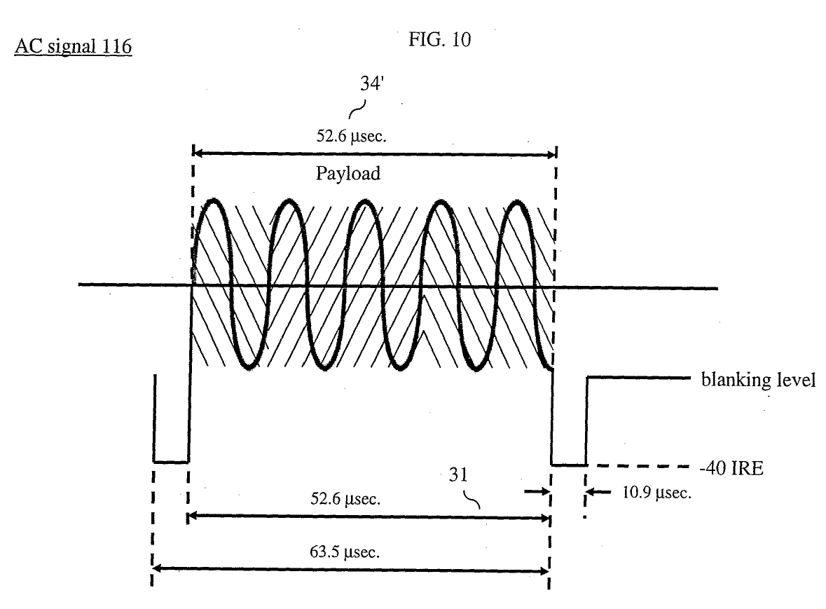

In view of the above observations, I have realized that it is possible to eliminate the need for a cyclic prefix without increasing the complexity or cost of the DMT receiver and still be able to cope with multipath. Thus, as can be observed from FIG. 10, the CP can be removed and greater information throughput can be achieved since the payload portion 34′ is now increased to 52.6 μsec. In particular, and in accordance with the principles of the invention, a DMT modulator modulates symbols with subcarriers for providing DMT symbols, wherein the subcarriers are divided into a number of subcarrier subsets such that adjacent DMT symbols use different subcarrier subsets. In other words, for any subcarrier S₁ of a symbol Xₖ, the symbols Xₖ₋₁ and Xₖ₊₁ do not contain the same-numbered subcarrier.

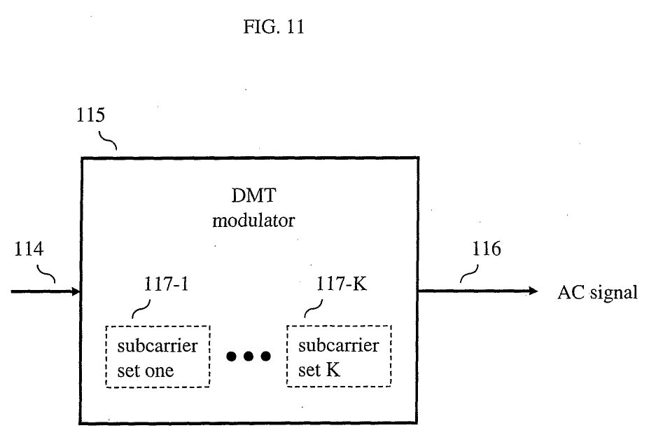

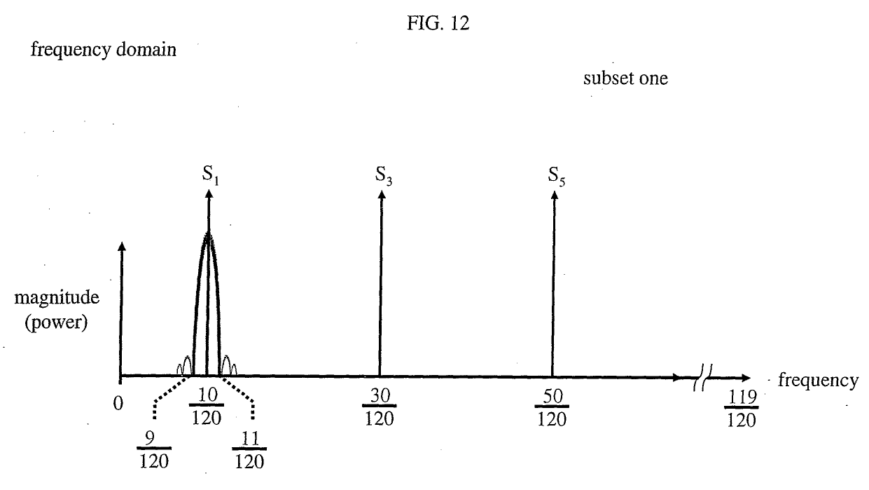

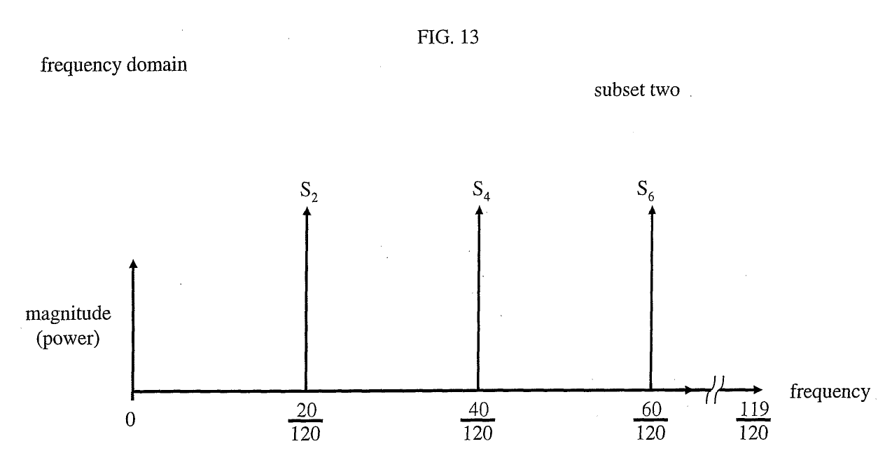

An illustrative embodiment of DMT modulator 115 in accordance with the principles of the invention is shown in FIG. 11. The latter is similar to FIG. 5 except that the arrangement of DMT modulator 115 is clarified to show that DMT modulation is performed by using K subcarrier subsets, 117-1 through 117-K, where K>1, such that adjacent DMT symbols provided by DMT modulator 115 use different subcarrier subsets. For example, continuing with the earlier-described illustration of a set of six subcarriers, S₁ through S₆, an illustrative partitioning of this set into subcarrier subsets for use by DMT modulator 115 is shown in FIGS. 12 and 13 for a value of K=2, i.e., for two carriers subsets. In particular, as shown in FIG. 12, subset one comprises the subcarriers S₁, S₃ and S₅; while, as shown in FIG. 13, subset two comprises the subcarriers S₂, S₄ and S₆. DMT modulator 115 uses the first subset to provide one DMT symbol and then the second subset for providing the following DMT symbol. In other words, the first subset is used for transmission of odd DMT symbols, and the second subset is used for transmission of even DMT symbols (or vice versa).

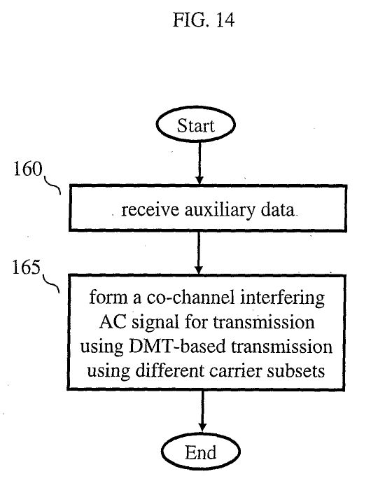

In view of the above, an illustrative flow chart for use in transmitter 105 in accordance with the principles of the invention is shown in FIG. 14. In step 160, transmitter 105 receives auxiliary data for the AC. The auxiliary data supports one, or more, services provided via an ATSC signal. In step 165, transmitter 105 forms a co-channel interfering signal to the ATSC signal in accordance with the principles of the invention. In this example, transmitter 105 transmits AC signal 116 as a DMT signal that imitates at least one spectral property of an NTSC broadcast signal using DMT-based transmission. In addition, the set of available subcarriers is divided into K subcarrier subsets and DMT modulator 115 forms adjacent DMT symbols using different subcarrier subsets.

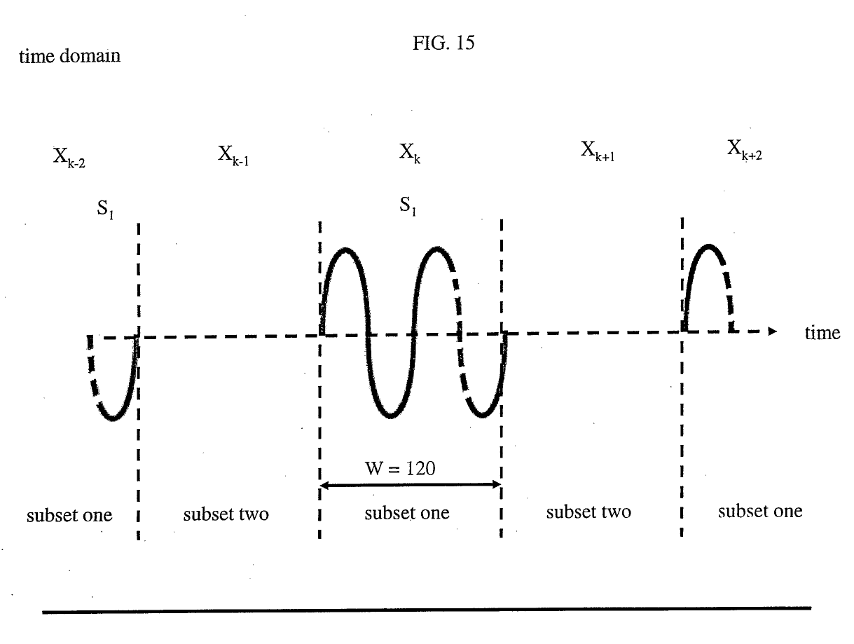

It should be noted that in order to ensure “link budget” preservation as compared to a legacy system additional steps may also be performed in transmitting the AC signal. For example, when there are two subcarrier subsets, with an equal number of subcarriers in each, the following two additional steps are also suggested in transmitting the AC signal. First, the power of each subcarrier in the subcarrier subset should be increased by a factor of 2 (by increasing the magnitude by a factor of √2). This way the total average signal power (and, hence, signal-to-noise ratio (SNR) into a receiver) will remain the same. Second, the TD window length should be reduced by a factor of 2, such that the TD duration of the new symbol pair (e.g., each of the two symbols in the pair containing one of the two non-overlapping subcarrier subsets) is the same as the single symbol duration of the old system. This way (in conjunction with the above-suggested power adjustment), for each received subcarrier, the ratio of the magnitude of the projection of the signal component and standard deviation of the projection of the noise component will remain the same as in the original system, thus preserving the Link Budget. This is further illustrated in FIG. 15, which shows a sample time domain sequence as “seen” by a receiver tuned to subcarrier S₁ (note that now W=120=240/2) for a sequence of transmitted DMT symbols Xₖ₋₂, Xₖ₋₁, Xₖ, Xₖ₊₁ and Xₖ₊₂. It can also be observed from FIG. 15, that adjacent DMT symbols alternate between using subcarrier subset one and subcarrier subset two.

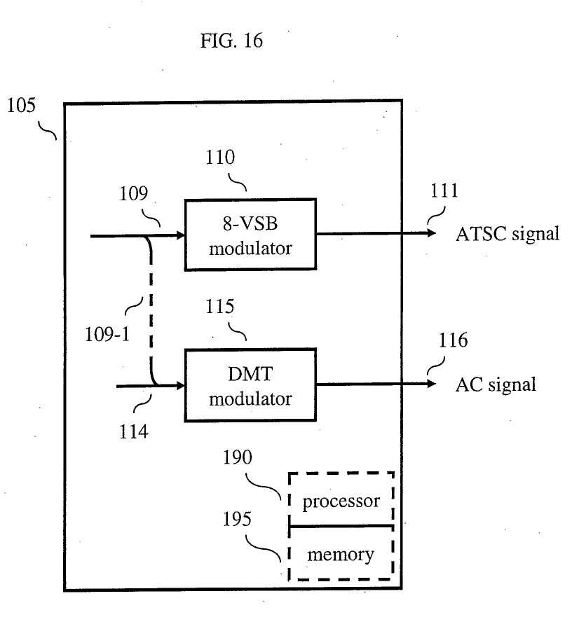

As noted above, the inventive concept allows a broadcaster to provide one, or more, services via the AC that supports one, or, more services provided via the ATSC signal. As one example, the AC is a support channel to facilitate reception of ATSC signal 111 (e.g., to allow the ATSC signal lobe received in a mobile environment as represented by mobile DTV 150 of FIG. 4). In this scenario, the broadcaster's advance knowledge of the information to be transmitted on the main ATSC channel (ATSC signal 111) is used to transmit support information on the AC channel, which is synchronized with the main ATSC channel. For example, assume an information stream relating to a program is scheduled to be transmitted, via ATSC signal 111, at a scheduled time T_{S}. Additional information, or a subset of the information stream to be transmitted via ATSC signal 111, is sent as auxiliary data, via AC signal 116, ahead of time at a time T_{E}. This auxiliary data is used by mobile DTV 150 to facilitate reception of ATSC signal 111. The value for T_{E} is chosen such that the resulting time interval T_{S}−T_{E} provides mobile DTV 150 enough time to process the auxiliary data before the arrival of the scheduled information stream via ATSC signal 111 at time T_{S}. Thus, mobile DTV 150 can receive-information on the AC channel to help receive the main ATSC channel. Illustratively, an especially advantageous way to use the AC channel for training is to send, as auxiliary data, data that is used for training (training data) and may also include data representing the location of the training data in ATSC signal 111. Thus, reception of the AC by mobile DTV 150 then enables mobile DTV 150 to further identify the training data and its location in the received version of ATSC signal 111. This variation of transmitter 105 is shown in FIG. 16 by dashed line 109-1, where a subset of data provided in ATSC signal 111 (e.g., training data) is also sent via DMT modulator 115.

As another example, the AC is an independent data or video channel that supports one, or more, services provided via the ATSC signal. For example, in a mobile environment, the ATSC broadcaster can transmit, via the AC, a lower resolution video as compared to the resolution of video conveyed via the ATSC signal. This lower resolution video can represent a program also conveyed via the ATSC signal or a completely different program that is simply at a lower resolution than video conveyed in the ATSC signal.

Similarly, the AC can be used for non-real-time transmissions of file-based information to pedestrian and mobile receivers that can store the information for later use.

As another example, the AC is a robust/fallback audio channel. An attribute of analog television transmission is that the sound will usually continue to work when the picture suffers momentary interference. Viewers will tolerate momentary freeze or loss of picture, but loss of sound is more objectionable. As such, another application of the AC is to provide an audio service that would be less likely to be affected by momentary reduction of a received signal level in an ATSC receiver.

As yet another example, the AC is an antenna pointing/diagnostic information provider for use in reception of the ATSC signal. Use of the AC to improve consumer “ease of use” would be helpful. As an example, diagnostic information could be displayed to help consumers with antenna pointing or, in conjunction with CEA Antenna Control Interface Standard,(CEA-909), facilitate automatic antenna pointing.

Thus, as described above, and in accordance with the principles of the invention, the AC conveys data associated with at least one service conveyed by the co-channel ATSC signal (main ATSC channel). In this context, the term “service” relates to one, or more of the following, singly or in combination: the type of information conveyed to a user, e.g., the AC may convey additional programming (news, entertainment, etc.) that is independent of, or related to, programming (news, entertainment; etc.) conveyed to the user by the main ATSC channel; the type of content conveyed in the main ATSC channel, e.g., the AC may convey additional news, audio and/or video etc., in a content format that is different from that conveyed in the main channel (e.g., the above-noted lower resolution video); the operation of the ATSC receiver, e.g., the AC may convey training information, setup information and/or diagnostic information, etc., in support of receiving the main ATSC channel.

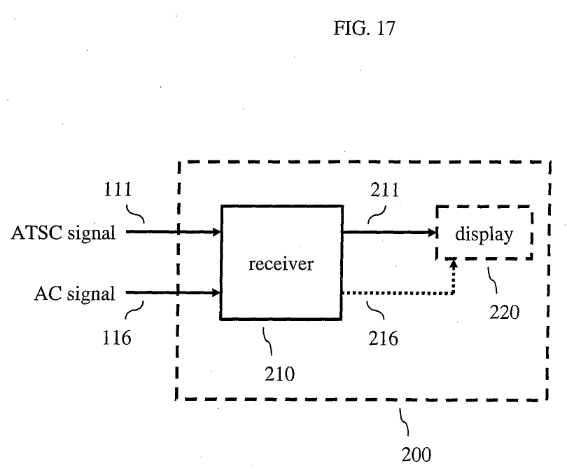

Referring now to FIG. 17, an illustrative embodiment of a device 200 in accordance with the principles of the invention is shown. Device 200 is representative of any processor-based platform, e.g., a PC, a server, a set-top box, a personal digital assistant (PDA), a cellular telephone, mobile DTV 150, DTV 155, etc. In this regard, device 200 includes one, or more, processors with associated memory (not shown) and also comprises receiver 210. The latter receives ATSC signal 111 and AC signal 116 via an antenna (not shown)). Receiver 210 processes received ATSC signal 111 to recover therefrom an HDTV signal 211 for application to a display 220, which may, or may not, be a part of device 200 as represented in dashed-line form. In addition, receiver 210 processes received AC signal 116 to recover therefrom auxiliary data 216. Depending on the particular service, the auxiliary data 216 may be used by receiver 210 itself (e.g., in the case of training data, described above), or the auxiliary data 216 can be provided to another portion of device 200, or external to device 200. One example is shown in FIG 17, where auxiliary data 216 (in dotted line form) represents low resolution video content. In this case, display 220 can use the low resolution video content of auxiliary data 216 instead of the high resolution video content of HDTV signal 211. Or, device 200 can select between HDTV signal 211 and the low resolution video of auxiliary data 216 as the video source for display 220. This selection can be performed in any number of ways, e.g., as a function of a comparison by receiver 210 between the corresponding signal-to-noise ratios (SNRs) for received ATSC signal 111 and received AC signal 116, where the signal with the highest SNR is selected.

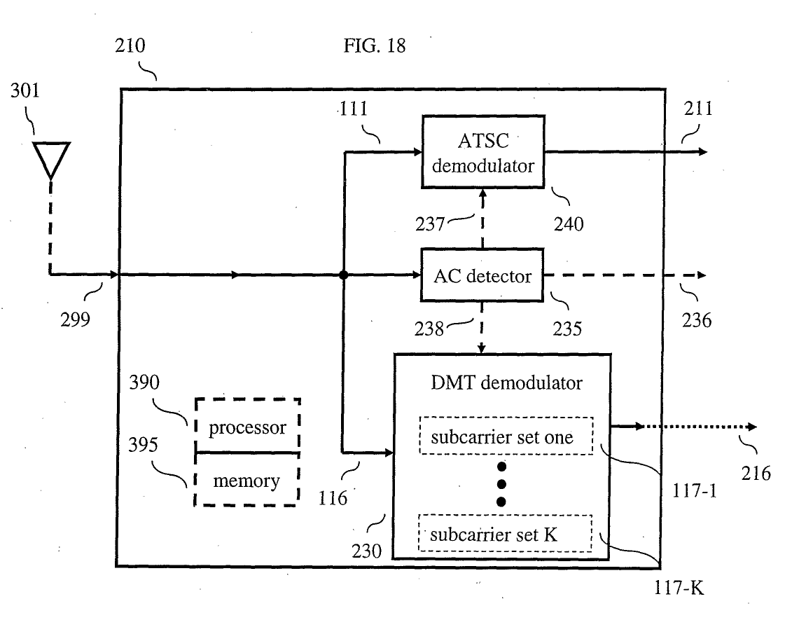

An illustrative embodiment of a receiver 210 in accordance with the principles of the invention is shown in FIG. 18. Receiver 210 comprises an ATSC demodulator 240, an AC detector 235 and a DMT demodulator 230. In addition, receiver 210 is a processor-based system and includes one, or more, processors and associated memory as represented by processor 390 and memory 395 shown in the form of dashed boxes in FIG. 18. In this context, computer programs, or software, are stored in memory 395 for execution by processor 390. The latter is representative of one, or more, stored-program control processors and these do not have to be dedicated to the receiver function, e.g., processor 390 may also control other functions of receiver 210. For example, if receiver 210 is a part of a larger device, processor 390 may control other functions of this device. Memory 195 is representative of any storage device, e.g., random-access memory (RAM), read-only memory (ROM), etc.; may be internal and/or external to transmitter 105; and is volatile and/or non-volatile as necessary.

Antenna 301 of FIG. 18 receives one, or more, broadcast signals and provides them to receiver 210 via input 299. In this example, antenna 301 provides ATSC signal 111 and also the co-channel interfering signal AC signal 116. It is assumed that receiver 210 is tuned to a particular channel for receiving, e.g., ATSC signal 111. ATSC demodulator 240 receives ATSC signal 111 and provides the above-mentioned HDTV signal 211. In this example, it is assumed that ATSC demodulator 240 also includes any required decoding functions. AC detector 235 monitors the currently tuned channel for AC signal 116. Since, in accordance with the principles of the invention, AC signal 116 looks like an NTSC co-channel signal, AC detector 235 may be constructed in a fashion similar to current NTSC signal detectors. Upon detection of the presence of AC signal 116, AC detector provides one, or more, signals as represented by any one of signals 236, 237 and 238 in dashed-line form. With respect to signal 237, this signal is provided to ATSC demodulator 240. The latter, in response to detection of the presence of AC signal 116, enables comb filters (not shown) of ATSC demodulator 240 to remove the interfering signal as it would for a co-channel interfering NTSC signal. With respect to signal 238, this signal is provided to DMT demodulator 230. Upon detection of AC signal 116, DMT demodulator 230 is activated to demodulate AC signal 116 to recover therefrom auxiliary data 216. With respect to signal 236, this signal may be provided to alert other portions of device 200, or another device, that an. AC signal has been detected. Finally, it should be noted that the earlier-noted TD portions of the signal, such as ‘dummy’ horizontal syncs of AC signal 1 16, can also be used by receiver 210 to help its reception by making it easier to locate the OFDM symbols in the AC stream.

As described above, and in accordance with the principles of the invention, a DMT-based transmitter utilizes different subcarrier subsets in forming the DMT symbols. As a result, the corresponding receiver has to be synchronized with the transmission pattern, i.e., the sequence of subcarrier subsets used by the DMT-based transmitter. In the context of the example above, for two subcarrier subsets, the transmission pattern can be viewed as an “odd/even” pattern. For example, for the first received DMT symbol the first subcarrier subset is used for demodulation; while for the second received DMT symbol the second subcarrier subset is used for demodulation, etc. Illustratively, this synchronization can be performed in any number of ways. For example, transmitter 105 transmits as a part of AC signal 116 a predefined training sequence of DMT symbols. Upon detection of a received AC signal by AC detector 235 of receiver 210, DMT demodulator 230 locks onto the received training sequence and begins to alternate between subcarrier subsets for demodulating the received DMT symbol data. For example, DMT demodulator 230 uses the first subcarrier subset for demodulating the first received DMT symbol and so on for each “odd” received DMT symbol, and uses the second subcarrier subset for demodulating the second received DMT symbol and so on for each “even” received DMT symbol (or vice-versa). Alternatively, different type of training sequences can be predefined in the system to represent different types of patterns of subcarrier subsets such that once DMT demodulator 210 identifies the particular training sequence the particular pattern of subcarrier subsets to use has also been identified by DMT demodulator 230. In addition, the particular pattern information can also be conveyed via an out-of-band channel as known in the art, e.g., as a part of system information conveyed in received ATSC signal 111.

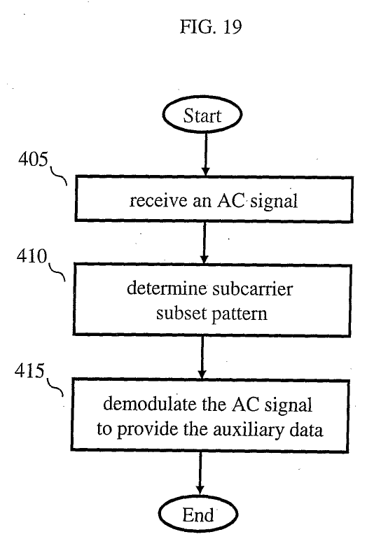

In view of the above, an illustrative flow chart for use in receiver 210 in accordance with the principles of the invention is shown in FIG. 19. In step 405, receiver 210 receives a broadcast AC signal 116 that conveys auxiliary data as a co-channel interfering signal to an ATSC transmission. In step 410, DMT demodulator determines the subcarrier subset pattern to use for demodulating received DMT symbols, e.g., by locking to a training signal. In step 415, receiver 210 demodulates the received AC signal to provide the auxiliary data.

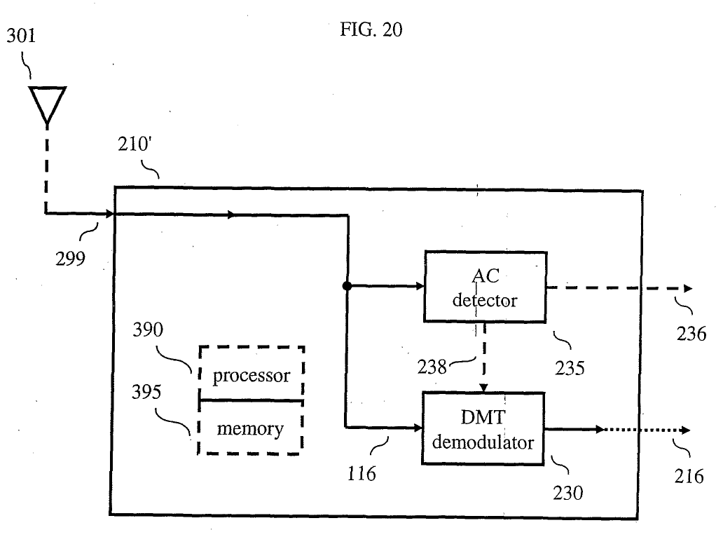

In addition to the illustrative embodiments shown above, another illustrative embodiment of a receiver in accordance with the principles of the invention is shown in FIG. 20. Receiver 210 is similar to receiver 210 of FIG. 18, except that there is no demodulator for the main ATSC channel. Instead, the AC is used to support services found in the main ATSC channel by providing these services to a user via the AC. For example, programming (news, entertainment) found in the main ATSC channel is provided to the user via the AC; and/or the type of content conveyed in the main ATSC channel is provided via the AC in a format different from that conveyed in the main channel (e.g., the above-noted lower resolution video); and/or the AC conveys auxiliary data related to the operation of receiver 201′, e.g., the AC may convey training information, setup information and/or diagnostic information, etc.

As described above, and in accordance with the principles of the invention, it is possible to eliminate the need for a cyclic prefix (also referred to as a cyclic extension or a guard band) in DMT-based systems—thus providing greater information throughput without incurring an appreciable increase in receiver complexity. As such, although the inventive concept was described in the context of an auxiliary channel in an ATSC transmission system, the invention is not so limited and is applicable to any DMT-based communications system. In addition, although the inventive concept was described in the context of an “odd/even” pattern, the inventive concept is not so limited and is applicable to any pattern of K subcarrier subsets. Further, although the inventive concept was described in the context of dividing the set of subcarriers into K subcarrier subsets, each subcarrier subset having the same number of subcarriers, the inventive concept is not so limited and one, or more, subcarrier subsets may have a different number of subcarriers than the other subcarrier subsets.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIGS. 14 and/or 19, etc. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. Apparatus comprising:
a discrete multi-lone (DMT) modulator for modulating symbols with subcarriers for transmitting DMT symbols;
wherein the subcarriers are divided into a number of subcarrier subsets such that adjacent DMT symbols are formed from different subcarrier subsets.

2. The apparatus of claim 1, wherein the subcarriers are divided into K subcarrier subsets such that each subcarrier subset is disjoint to the other subcarrier subsets.

3. The apparatus of claim 2, wherein each subcarrier subset has the same number of subscriber as the other subcarriers subsets.

4. The apparatus of claim 2, wherein K is equal to two and the DMT modulator alternates between subcarrier subsets in forming the DMT symbols.

5. The apparatus of claim 4, wherein the number of subcarriers is six.

6. The apparatus of claim 1, further comprising:
an ATSC DTV (Advanced Television Systems Committee-Digital Television) modulator for conveying data representing a high definition television (HDTV) service;
wherein the DMT symbols represent auxiliary channel data for the HDTV service.

7. The apparatus of claim 6, wherein the DMT modulator forms the auxiliary channel such that the auxiliary channel imitates at least one spectral property of an NTSC broadcast signal.

8. Apparatus comprising:
a discrete multi-tone (DMT) demodulator for demodulating received DMT symbols to provide recovered data;
wherein for each received DMT symbol, the DMT demodulator uses a subcarrier subset for demodulating the received DMT symbol and wherein the DMT demodulator uses different subcarrier subsets for demodulating adjacent received DMT symbols.

9. The apparatus of claim 8, wherein the subcarriers are divided into K subcarrier subsets such that each subcarrier subset is disjoint to the other subcarrier subsets.

10. The apparatus of claim 9, wherein each subcarrier subset has the same number of subcarriers as the other subcarriers subsets.

11. The apparatus of claim 9, wherein K is equal to two and the DMT demodulator alternates between subcarrier subsets in demodulating received DMT symbols.

12. The apparatus of claim 11, wherein the number of subcarriers is six.

13. The apparatus of claim 8, further comprising:
an ATSC DTV (Advanced Television Systems Committee-Digital Television) demodulator for recovering therefrom an HDTV signal;
wherein the recovered data provided by the DMT demodulator represents auxiliary data associated with the HDTV signal.

14. The apparatus of claim 13, further comprising:
a detector for enabling the DMT demodulator by detecting a presence of a signal representing the received DMT symbols, wherein the detector detects the presence by detecting at least one spectral property of an NTSC (National Television Systems Committee) broadcast signal in the signal.

15. A method for use in a transmitter comprising:
receiving data for transmission;
modulating the received data using a discrete multi-tone (DMT) based modulation to provide a sequence of DMT symbols for transmission;
wherein DMT subcarriers are divided into a number of subcarrier subsets such that adjacent DMT symbols are formed from different subcarrier subsets.

16. The method of claim 15, wherein the subcarriers are divided into K subcarrier subsets such that each subcarrier subset is disjoint to the other subcarrier subsets.

17. The method of claim 16, wherein each subcarrier subset has the same number of subcarriers as the other subcarriers subsets.

18. The method of claim 16, wherein K is equal to two and the modulating step alternates between subcarrier subsets in forming the DMT symbols.

19. The method of claim 18, wherein the number of subcarriers is six.

20. The method of claim 15, further comprising
modulating data to provide an ATSC DTV (Advanced Television Systems Committee-Digital Television) signal for conveying data representing a high definition television (HDTV) service;
wherein the DMT symbols represent auxiliary channel data for the HDTV service.

21. The method of claim 20, wherein the DMT modulating step forms the auxiliary channel such that the auxiliary channel imitates at least one spectral property of an NTSC broadcast signal.

22. A method for use in a receiver, the method comprising:
receiving DMT symbols;
demodulating each received DMT symbol to provide recovered data using a subcarrier subset, wherein different subcarrier subsets are used for demodulating adjacent received DMT symbols.

23. The method of claim 22, wherein the subcarriers are divided into K subcarrier subsets such that each subcarrier subset is disjoint to the other subcarrier subsets.

24. The method of claim 23, wherein each subcarrier subset has the same number of subcarriers as the other subcarriers subsets.

25. The method of claim 23, wherein K is equal to two and the demodulating step alternates between subcarrier subsets in demodulating received DMT symbols.

26. The method of claim 25, wherein the number of subcarriers is six.

27. The method of claim 22, further comprising:
demodulating a received ATSC DTV (Advanced Television Systems Committee-Digital Television) signal for recovering therefrom an HDTV signal;
wherein the recovered data provided by the DMT demodulating step represents auxiliary data associated with the HDTV signal.

28. The method of claim 27, further comprising:
detecting a presence of a signal representing the received DMT symbols, wherein the detecting step detects the presence by detecting at least one spectral property of an NTSC (National Television Systems Committee) broadcast signal in the signal; and
if the signal representing the received DMT symbols is present, performing the DMT demodulating step.

29. The method of claim 22, wherein the demodulating step includes:
determining a subcarrier subset pattern for use in demodulating each received DMT symbol with a particular subcarrier subset.

30. The method of claim 29, wherein the determining a subcarrier subset pattern includes the step of:
detecting a training sequence associated with the subcarrier subset pattern.
